(19) United States
(12) Patent Application Publication
(10) Pub. No.: US 2004/0124971 A1
(43) Pub. Date: Jul. 1, 2004

(54) Method to provide integrated information in a vehicle

(75) Inventors: Thomas J. MacTavish, Inverness, IL (US); Shrirang Nilkanth Jambhekar, Palatine, IL (US); William F. Zancho, Hawthorn Woods, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/329,611

(22) Filed: Dec. 26, 2002

(51) Int. Cl. B60Q 1/00

(52) U.S. Cl. 340/425.5

(57) ABSTRACT

Inputs from a plurality of information sources including in-vehicle sensors (11, 12, and 13) are collected by a processing unit (14) to provide an integrated consideration of such inputs specific to the characteristics of the current driver. This integrated consideration is then used to source a couching output that is suitable for a driver of the vehicle.

### TECHNICAL FIELD

This invention relates generally to vehicles and more particularly to terrestrial vehicles and the provision of information to drivers of such vehicles.

### BACKGROUND

Vehicles of various sorts are well known in the art and include free-ranging terrestrial vehicles (such as automobiles, trucks, recreational vehicles, construction equipment, and the like) that are usually piloted by a driver. Numerous technological advancements have accompanied the design and manufacture of such vehicles in recent times. Such advancements relate to a wide variety of technological contexts and include vehicle operation, navigation, driver or passenger comfort or safety, entertainment, communications, maintenance, law enforcement, environmental impact, fleet participation, scheduling, and performance, to name a few with yet other advancements being discussed and/or introduced on a regular basis.

Many of these advancements must, or at least can, provide corresponding information to the vehicle driver at least from time to time. Unfortunately, for the most part, driver informational systems have not kept pace with the ever-increasing flow in information intended for the driver's attention. Instead, the sheer quantity of information simply continues to expand either through addition of yet additional displays or by nesting access to the information within, for example, menu-style display mechanisms. At best, such proliferating displays (or other corresponding information-imparting devices, such as audio platforms) are annoying, difficult to use effectively, and/or are simply ignored by the driver. At worst, this informational overflow has the significant potential to distract a driver from the primary task at hand; the safe and accurate maneuvering of the free-ranging vehicle being piloted by the driver.

One prior art approach that attempts to address such a concern shares a single display mechanism with a plurality of information inputs. For example, many automobiles provide a dashboard-mounted indicia reading something like “Check Engine,” which indicia is illuminated in response to when any of a plurality of monitored parameters exceed a corresponding predetermined performance threshold. Such an approach does have the advantage of minimizing, for these monitored parameters, the number of potential messages that are provided to the driver. On the other hand, such an approach often treats the individual parameters and their present readings as being essentially equal. As a result, the same message to the driver is provided regardless of the genuine severity of the situation. Furthermore, such an approach operates in a repeatedly similar fashion regardless of any interplay as between the monitored conditions. Therefore, while perhaps suitable for some conditions, in general such a non-discriminating and un-integrated approach leaves much to be desired.

### BRIEF DESCRIPTION OF THE DRAWINGS

The above needs are at least partially met through provision of the method to provide integrated information in a vehicle described in the following detailed description, particularly when studied in conjunction with the drawings, wherein:

FIG. 1 comprises a block diagram depiction of a system as configured in accordance with various embodiments of the invention;

FIG. 2 comprises a flow diagram as configured in accordance with various embodiments of the invention;

FIG. 3 comprises a detailed flow diagram as configured in accordance with various embodiments of the invention; and

FIG. 4 comprises a flow diagram as configured in accordance with another embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, information is received from a plurality of information sources including in-vehicle sensors. This information is processed to provide an integrated consideration thereof. An output is then provided, which output at least corresponds to the integrated consideration.

In one embodiment, the integrated consideration includes comparing sensor information with one another. In another embodiment the integrated consideration includes characterizing items of sensor information (for example, by characterizing the sensor information with respect to degree of importance, by weighting the sensor information, or by conceptually normalizing the sensor information to facilitate their integrated consideration). In one embodiment, information from other sources can also be used when making the integrated consideration. The other sources can be within the vehicle or remote as desired. The information from the other sources can include a variety of topics including non-vehicular information regarding the driver and/or the vehicle environment.

So configured, by integrating the information for analysis and/or synthesis purposes and then providing a corresponding representative output to the driver, considerable quantity reduction in the discrete display can be achieved. Furthermore, and perhaps more beneficially, information can be provided that is intrinsically and/or more quickly of better use to a driver than is typically achieved with a multitude of discrete displays that challenge the cognitive loading of the driver.

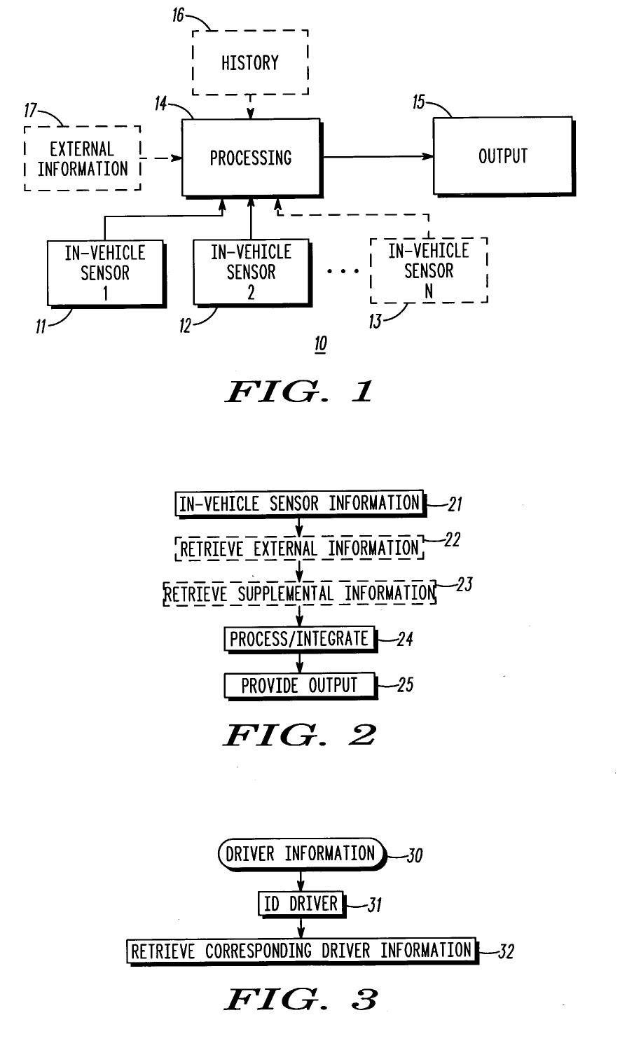

Referring now to FIG. 1, relevant elements of a processing platform 10 suitable to support the functionality set forth below are presented. Generally speaking, the platform 10 will be disposed within a vehicle such as a free-ranging terrestrial vehicle (though, if desired, many of the elements could be effected remotely through provision and use of a suitable communications link).

Typically, at least two in-vehicle sensors 11 and 12 are provided. As appropriate to the application and context, however, any greater number of in-vehicle sensors can be provided as represented here by an Nth in-vehicle sensor 13. Such sensors can be considerably varied and, though mounted “in-vehicle” (meaning that the sensor is disposed either in or on the vehicle under consideration), can monitor conditions both in and external to the vehicle. A partial list of candidate in-vehicle sensors, intended for purposes of illustration only and not intended to be exhaustive, would include:

engine performance indicators;

fluid level indicators;

temperature indicators (including external and internal ambient temperatures as well as the temperature of various vehicle performance zones);

emissions content;

vehicle heading;

vehicle speed and/or acceleration;

lane-keeping indicators;

distance-to-objects information;

communications links performance/availability indicators;

maintenance indicators;

internal vehicular sensors;

cellphone in use;

entertainment system in use;

eye tracking;

hand location detection;

presence of other occupants;

driver habits:

pacing

breaking

turning

passing

other conditions;

road

weather

\traffic

driver's psychological state

and so forth. Such sensors/information sources are understood in the art and hence additional description will not be set forth here for the sake of brevity and the preservation of explanatory focus.

A processing unit 14 receives the outputs from these various information sources. In general, the processing unit 14 serves to analyze and otherwise process the source outputs, often with respect to a plurality of policies that serve to correlate multiple differing information inputs from the sources to output content that itself constitutes an integrated consideration of the differing information inputs from the plurality of sources, including various in-vehicle sensors. Such a processing unit 14 can be provided in a variety of ways. For example, programmable platforms such as one or more microprocessors and/or microcontrollers (along with corresponding memory as needed to support a given application) are appropriate for use in this context. In the alternative, or as a supplement to such a soft-programmable platform, hardwired logic circuits and/or programmable gate arrays can also serve to effectuate the processing needs of these embodiments. Such processing platforms, along with various ways to couple, buffer, and/or digitize source information for provision to such platforms, are well known in the art. Therefore, no additional description need be provided here.

As noted, an overall purpose of the processing unit 14 is to process information from the sensors to thereby yield an integrated consideration of the sensor information and thereby provide an output 15 that corresponds to this integrated consideration. Such integrated consideration can be effected in a wide variety of ways, depending in large part upon the particular sensor inputs that are to be processed in this way. Some illustrative examples are presented below. It should be noted, however, that integration of the sensor inputs constitutes more than merely, for example, sharing a single display indicator over a plurality of such sensors. Instead, it contemplates a studied fusion of the sensor information to yield an output result that reduces cognitive loading by fairly representing a balanced view-of-the-whole for the monitored parameters and conditions.

Various tools and approaches can be used to facilitate, in a given instance, such an integrated consideration. A partial list of candidate approaches, intended for purposes of illustration only, would include comparing the sensor information against one another. To facilitate such comparisons, especially where the sensor data does not share, for example, a common unit or scale, it may be appropriate to first characterize the sensor information. Such characterization can serve, for example, to categorize the sensor inputs with respect to a relative degree of importance or to normalize the information to thereby better facilitate their comparison.

Characterization can also serve to weight the sensor data to thereby pre-influence the comparison process. Such weighting can be driven, for example, by predetermined prioritization data that increases or decreases the relative significance of a given sensor's input with respect to other sensor information. If desired, historical information 16 (as stored locally or as obtained from a remote source) can also be provided to the processing unit 14. When appropriate historical information is so provided, the historical information can be used, for example, to inform the weighting process just referenced. The historical information can relate to any of a variety of candidate topics, including for example, the driver themselves, the vehicle (including past performance and/or maintenance history), and the roadway itself under various driving conditions).

Also if desired, supplemental information and/or external information 17 (meaning, in general, information that is apart from immediate operation of the vehicle itself) can also be provided (again from a local and/or a remote source), which external information can then be used to influence such weighting. For example, the external information can comprise information regarding the present driver of the vehicle. Such external information can itself comprise historical information, such as historical information regarding the driver (for example, statistical information regarding the driver, either with respect to general driving abilities or with respect to specific driving conditions and the driver's corresponding success or failure when faced with such circumstances) or personal characteristics information regarding the driver (such as, for example, age, gender, physical abilities and disabilities, and so forth).

Another example of potentially suitable external information includes mandatory policies, particularly as they pertain to a given driver of the vehicle (such mandatory policies can be as dictated by, for example, a parent or guardian of the driver, an insuring party, or a legal authority such as a court or parole/probation officer). Such information can be used to weight more heavily, for example, sensor data reflecting violation (or an approaching violation) of a policy that otherwise might not constitute as significant a concern.

Yet another example of suitable supplemental or external information comprises vehicle environment information, such as information regarding the immediate environment (anything from status of local weather to local road construction) or information regarding at least upcoming portions of the vehicle's intended route.

The external information 17 as noted above can be provided in a variety of ways. One approach would be to provide a wireless communications link (such as a Dedicated Short Range Communications (DSRC) transceiver) in the vehicle to permit receipt of various kinds of roadside and/or journey-related information (such as weather information, road condition information, local traffic information, and even updated information regarding the vehicle itself from, for example, a manufacturer, dealer, or service provider). For example, accident rate information for a specific model of vehicle during specific environmental conditions (time of day, day of week, weather, degree of traffic congestion, and so forth) as correlate to present conditions could be transmitted by a DSRC beacon, and such accident rate information could be used as external or supplemental information accordingly.

As noted earlier, the above-described system serves as a platform to enable the activity described. With reference to FIG. 2, that activity includes receiving 21 in-vehicle sensor information along with, optionally, such external information 22 and supplemental information 23 as may be desired and appropriate to a given application. As noted, this could include, for example, obtaining information specific to the driver.

For example, with reference to FIG. 3, to obtain 30 driver information, the driver could be identified 31 and corresponding information for that driver retrieved 32. A driver can be identified through various mechanisms, including by entry of a corresponding identifier (such as a personal identifier number or password) and/or through use of biometrics such as fingerprint or voiceprint sensing and comparison. And, again as noted above, the retrieval of some or all of the driver information can be made with respect to a local or a remote data storage facility in accordance with well understood prior art technique.

Referring again to FIG. 2, these various sensor and additional information inputs are processed 24 to yield an integrated result, which result is then used to provide 25 a corresponding output. As a simple illustration, the output could comprise a specific driving instruction that constitutes an integrated reaction to the incoming information.

The above descriptions provide a view of various embodiments for facilitating and effecting an integrated consideration of multiple in-vehicle sensor inputs (supplemented as desired with additional internal and externally sourced information) through, for example, comparison, characterization, weighting, normalization, and so forth. A number of illustrative examples are now provided. The intent in providing these examples is to facilitate an understanding of these various embodiments. These examples are not to be viewed as constituting an exhaustive listing of potential specific embodiments nor as otherwise limiting the scope of the invention in general.

### EXAMPLE 1

Virtually all vehicles have a fuel gauge that typically displays some measure of remaining fuel. Some vehicles supplement this basic display with one or more additional displays or audible indicia to provide specific fuel-event alerts. For example, some vehicles have a “Check Gauge” display that illuminates when the remaining fuel supply reaches a predetermined quantity. Many vehicles also have an on-board navigation platform having access to the vehicle's present position, heading, and present destination. By employing the teachings set forth above, information input from the fuel gauge sensor and the navigation platform can be fused to provide useful information to a driver that otherwise presently relies upon the driver themselves to divine. For example, although the remaining fuel quantity may exceed the threshold quantity that would otherwise trigger the “Check Gauge” message, the “Check Gauge” message could nevertheless be illuminated when the present heading and destination of the vehicle presents a considerable risk that the vehicle will consume the present fuel supply before a refueling opportunity will likely be found. In one embodiment, the illumination of the “Check Gauge” message could be effected in a manner that differentiates it from the more ordinary trigger event. For example, the illumination can be strobed to distinguish it from a more ordinary presentation when it is merely continuously lit.

In the above example, the driver can of course be presented with all of the raw data to permit the driver's being able to reach the same conclusion regarding the present fuel quantity. As already noted, however, the ever increasing quantity and variety of display indicia presents a risk that such a driver will not always be able to rise to the requisite cognitive challenge of noticing and processing these basic inputs in a timely or accurate fashion. By fusing the sensor/informational inputs in this manner, and by leveraging existing displays rather than adding yet more displays, the cognitive loading remains manageable while simultaneously ensuring that the driver benefits through access to such helpful information.

### EXAMPLE 2

Some vehicles have a display to indicate a remaining quantity of lubrication fluid while virtually all provide a simple light to indicate when the lubrication fluid level has fallen dangerously low. By combining the output of a lubrication fluid level sensor with calendar information in accordance with these teachings, information regarding an impending holiday season (when lubrication fluid change facilities may be less conveniently available) can be combined with information that lubrication fluid level is nearing a low level to yield provision of a “Change Oil Now” message to the driver. So configured, the driver can attend to the lubrication fluid needs of the vehicle somewhat ahead of schedule in order to ensure that these needs do not become critical during a considerably less convenient timeframe. At the same time, such information, when integrated in accordance with these teachings, does not necessarily contribute to display growth; that is, yet further dedicated displays (or nested displays) are not required, thus again serving to simplify the cognitive tasks placed upon the driver.

### EXAMPLE 3

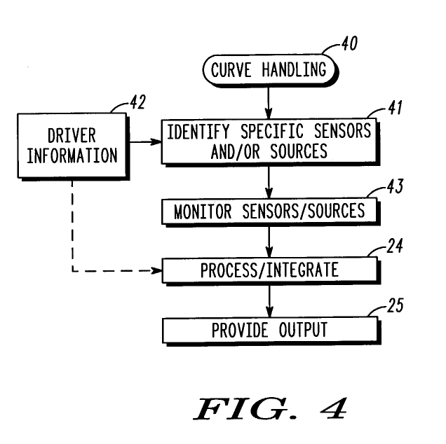

Driver information as noted above (including but not limited to the driver's past driving performance in various circumstances, the driver's habits and preferences, the driver's skill level and abilities, and so forth) can be utilized to inform the fusion process, and in particular can aid in determining which sensor inputs and information sources to fuse and further which of these inputs and sources, if any, to weight more heavily in the overall integration process. For example, and referring now to FIG. 4, a curve handling 40 process can begin with an identification 41 of specific sensors and/or information sources to utilize during the curve handling process 40. For various reasons, it may not be appropriate and/or necessary to select each and every sensor and source (to conserve computational capability, facilitate a speedy determination, and so forth). The process 40 can therefore begin by selecting from amongst all (or some other previously ascertained subset) of the on-board sensor systems and internal and external information sources. In general, the process 40 will select sensors and sources that tend to provide information of potential forecasting or real-time value with respect to handling of the roadway curve.

In this example, driver information 42 informs the sensor/source identification activity 41. For example, when the driver is known to have lengthy driving experience with no record of driving problems in general or with curve handling in particular, the process 40 may identify only real-time sensors (such as, for example, sensors that provide information regarding vehicle suspension and its attendant control, vehicle center of gravity, vehicle speed and turning radius). These real-time sensors are then monitored 43, with the resultant information being processed and integrated 24 as generally suggested above to yield an attendant appropriate output 25.

When the driver information 42 indicates, however, that the driver is less experienced, or has habits or a driving history that suggests that the driver has problems with curve handling, the process 40 can identify, in addition to real-time sensor information as noted above, additional information sources such as real-time vehicle navigation information that can be used to anticipate a curve, information regarding the roadway angle and approaching curve radius, time of day information, current driving conditions (particularly as impact upon visibility and/or roadway traction), and so forth. Such information is then monitored 43 and again processed and integrated 24 in accordance with these teachings. So configured, the process 40 can utilize additional information in this case to consider the present and anticipated driving circumstances to thereby effect provision of an appropriate output as required.

If desired, the driver information 42 can also be used to better inform or shape the processing and integration 24 as well. For example, the driver information 42 can be used to weight one or more of the sensors or information sources. If the driver information 42 indicates that this driver has considerable difficulty when handling curves at night in the rain, then information indicating such conditions can be weighted as being of higher import. The resultant processing and integration of such information will therefore tend to reflect this weighted bias (for example, the resultant output may, under such circumstances, provide a more urgent or earlier warning due to such weighting).

In general, then, these teachings can be applied to aid in the collection of only likely relevant information from sensors and/or information sources, with relevance being defined as a function of the information that tends to characterize the driver. In effect, the fusion process is sensitized for a given driver.

Such historical information can be gleaned from a number of sources. Pursuant to one embodiment, the information can be gathered from an expert observer (such as, for example, a driving instructor or testing personnel at a government licensing agency). For example, specific ratings, grades, or other characterizing information can be obtained for a variety of specific driving activities such as, but not limited to: driving in a residential area, driving in an urban area, driving in a rural area, driving in heavy traffic, driving on an expressway, and various specific driving tasks (such as, but not limited to: parking on an incline, backing up, changing lanes, parking at an angle, parallel parking, passing, and execution of a turnabout). As another example, specific ratings, grades, or other characterizing information as often obtained for a variety of specific driving activities during driving instruction can be used, such as, but not limited to:

Starting and putting a vehicle into motion

Fastening seat belt

Locking doors

Adjusting seat and mirrors properly

Checking mirrors

Checking blind spot

Steering

Positioning of hands

Smoothness of steering

Use of both hands

Use of accelerator

Hard acceleration

Timid acceleration

Smoothness of acceleration

Speed control

Too fast for conditions

Too slow for conditions

In excess of posted limit

Use of brake

Use of proper foot

Braking too hard

Braking too soft

Smoothness of braking

Releasing brake too soon

Not applying brake soon enough

Stopping at stop signs and signals

Stopping too soon

Overrunning stop line

Abrupt stop

Failing to come to a complete stop

Stopping too close to the vehicle ahead

Improper right hand turn on red

Use of turn signals

Failure to signal when pulling into or leaving a curb

Failure to cancel signal

Failure to signal lane change

Signaling too late

Signaling too soon

Failing to signal a turn

Right turns and left turns

Approaches from improper lane position

Too fast

Too slow

Use of hand-over-hand motion on steering wheel

Failure to straighten when leaving turn

Turns too wide

Turns too sharp

Turning into a wrong lane

3 point turns

Checking both directions

Stopping before contacting curb

Looking before backing up

Shifting to the correct gear

Angle and perpendicular parking

Approaching from too close to parked cars

Turning wheel too soon

Turning wheel too late

Finishing with wheels straight

Checking traffic behind before backing

Turning wheel the correct direction when backing

Entering too fast

Expressway driving

Gap selection while on entrance ramp

Adjusting speed to traffic

Signaling, mirror checking, and headchecking when merging

Lane drifting

Proper space cushion

Adjusting speed on ramps

Intersections

Failure to identify intersections

Failure to identify intersection controls

Failure to identify other vehicles

Failure to yield the right of way

Failure to look in all directions

Gap selection when turning

Failure to respond to potentially hazardous situation

Lane position

Failure to drive in proper lane

Straddling traffic lanes

Drifting in lane

Driving to side of lane

Driving too close to parked cars

Driving too wide from parked cars

Appropriate following distance

Hill parking

Turning wheels the wrong way

Shifting to neutral

Rolling against curb

Starting more than twelve inches from curb

Setting parking brake

Backing up

Failure to look behind while backing

Failure to center car in lane

Oversteering

Zigzagging

Failure to check traffic left and right

Wide turn

Poor steering wheel hand position

Lane changes

Checking mirrors

Checking blind spot

Signaling

Maintaining speed

Adjusting speed

Turning wheel too sharply

Drifting during blindspot check

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method for providing information in a vehicle, comprising:
receiving information from a plurality of sources comprising any of in-vehicle sensors and external information sources;
processing the information to at least provide an integrated consideration of at least a first item of information from a first one of the sources and a second item of information from a second one of the sources;
providing an output that corresponds to the integrated consideration.

2. The method of claim 1 wherein providing an integrated consideration of at least two items of information includes comparing the first and second items of information with one another.

3. The method of claim 2 wherein comparing the first and second items of information includes characterizing at least one of the first and second items of information.

4. The method of claim 3 wherein characterizing at least one of the first and second items of information includes characterizing the first and second items of information as being of a substantially same degree of importance.

5. The method of claim 3 wherein characterizing at least one of the first and second items of information includes conceptually normalizing at least one of the first and second items of information to facilitate an integrated consideration of the first and second items of information.

6. The method of claim 2 wherein comparing the first and second items of information includes weighting at least one of the first and second items of information.

7. The method of claim 6 wherein weighting at least one of the first and second items of information includes accessing historical information.

8. The method of claim 6 wherein weighting at least one of the first and second items of information includes accessing prioritization data.

9. The method of claim 6 wherein weighting at least one of the first and second items of information includes accessing information regarding a driver of the vehicle.

10. The method of claim 9 wherein accessing information regarding a driver of the vehicle includes accessing historical information regarding a driver of the vehicle.

11. The method of claim 10 wherein accessing historical information regarding a driver of the vehicle includes accessing statistical information regarding the driver.

12. The method of claim 9 wherein accessing information regarding a driver of the vehicle includes accessing personal characteristics information regarding a driver of the vehicle.

13. The method of claim 9 wherein accessing information regarding a driver of the vehicle includes accessing mandatory policies regarding a driver of the vehicle.

14. The method of claim 1 wherein providing an output includes providing at least one specific driving instruction that constitutes an integrated reaction to the at least two items of information.

15. The method of claim 1 and further comprising providing at least one item of non-vehicular information and wherein providing an integrated consideration of at least a first item of information from a first one of the plurality of sources and a second item of information from a second one of the plurality of sources includes providing an integrated consideration of the at a first item of information from a first one of the plurality of sources and a second item of information from a second one of the plurality of sources and the at least one item of non-vehicular information.

16. The method of claim 15 wherein providing at least one item of non-vehicular information includes providing at least one item of vehicle driver information.

17. The method of claim 16 wherein providing at least one item of vehicle driver information includes providing at least one item of historical information regarding a vehicle driver.

18. The method of claim 16 wherein providing at least one item of vehicle driver information includes providing at least one item of characterizing information regarding a vehicle driver.

19. The method of claim 15 wherein providing at least one item of non-vehicular information includes providing at least one item of vehicle environment information.

20. The method of claim 19 wherein providing at least one item of vehicle environment information includes providing at least one item of vehicle immediate environment information.

21. The method of claim 19 wherein providing at least one item of vehicle environment information includes providing at least one item of environment information that includes at least a portion of the vehicle's intended route.

22. The method of claim 19 wherein providing at least one item of vehicle environment information includes providing historical information regarding a specific vehicle environment.

23. The method of claim 19 wherein providing at least one item of vehicle environment information includes receiving a radio frequency transmission that includes the at least one item of vehicle environment information.

24. The method of claim 23 wherein receiving a radio frequency transmission includes receiving a digital short-range radio frequency transmission that is compatible with a roadside information service.

25. The method of claim 1 and further comprising selecting the plurality of sources from amongst a first plurality of sources.

26. The method of claim 25 and further comprising determining at least one item of driver information and wherein selecting the plurality of sources from amongst a first plurality of sources includes selecting the plurality of sources from amongst a first plurality of sources as a function, at least in part, of the at least one item of driver information.

27. The method of claim 26 wherein processing the information to at least provide an integrated consideration of at least a first item of information from a first one of the sources and a second item of information from a second one of the sources includes weighting at least one of the first and second item of information as a function, at least in part, of the at least one item of driver information.

28. A method for providing information in a vehicle, comprising:
receiving information from a plurality of in-vehicle sensors wherein the sensors sense different conditions with respect to the vehicle;
providing a plurality of policies that correlate multiple differing information inputs from the plurality of in-vehicle sensors to a plurality of different output content that constitutes an integrated consideration of the differing information inputs from the plurality of in-vehicle sensors;
providing a specific output that corresponds to the output content.
